(19) United States
(12) Patent Application Publication
(10) Pub. No.: US 2017/0092334 A1
(43) Pub. Date: Mar. 30, 2017

(54) ELECTRONIC DEVICE AND METHOD FOR VISUALIZING AUDIO DATA

(71) Applicant: Kabushiki Kaisha Toshiba, Tokyo (JP)

(72) Inventor: Ryuichi Yamaguchi, Ome Tokyo (JP)

(21) Appl. No.: 15/270,821

(22) Filed: Sep. 20, 2016

Related U.S. Application Data
(60) Provisional application No. 62/233,092, filed on Sep. 25, 2015.

(51) Int. Cl. G11B 27/34; G06F 3/16; G11B 20/10

(52) U.S. Cl. CPC G11B 27/34; G11B 20/10527; G06F 3/165; G11B 2020/10546

(57) ABSTRACT

According to one embodiment, an electronic device includes a memory, a microphone, a display and a hardware processor. The hardware processor cause the memory to record audio data corresponding to a sound input via the microphone, produces first images by capturing an image displayed on the display while the audio data is recorded, selects second images from the first images, based on variations between images, and displays a third image of the second images on a screen of the display if the audio data is reproduced, the third image corresponding to a current reproduction position of the audio data.

### CROSS-REFERENCE TO RELATED APPLICATIONS

This application claims the benefit of U.S. Provisional Application No. 62/233,092, filed Sep. 25, 2015, the entire contents of which are incorporated herein by reference.

### FIELD

Embodiments described herein relate generally to technology for visualizing a summary of recorded data.

### BACKGROUND

Recently, various electronic devices such as personal computers (PC), tablets and smartphones have been developed. Most of the electronic devices of this type can handle various audio sources such as music, speech and other various sounds.

Conventionally, however, technology of presenting a summary of recorded data which is recorded in a meeting to a user in an easily understandable form such as minutes has not been considered. For this reason, the user needs to find a desired portion while reproducing the recorded data.

A new visualization technology of enabling contents of recorded data to be easily understood is therefore required.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an appearance of an electronic device according to an embodiment.

FIG. 2 is an exemplary block diagram showing a system configuration of the electronic device.

FIG. 3 is an exemplary block diagram showing a functional configuration of a sound recorder application program executed by the electronic device.

FIG. 4 is an exemplary illustration to explain analysis processing to delete a redundant screen image from screen images captured during recording.

FIG. 5 is an exemplary illustration to explain analysis processing to delete a redundant screen image of screen images captured during recording.

FIG. 6 is an exemplary illustration showing a home view displayed by the electronic device executing the sound recorder application program.

FIG. 7 is an exemplary illustration showing a recording view displayed by the electronic device executing the sound recorder application program.

FIG. 8 is an exemplary illustration showing a play view displayed by the electronic device executing the sound recorder application program.

FIG. 9 is an exemplary illustration to explain an operation for the play view displayed by the electronic device executing the sound recorder application program.

FIG. 10 is an exemplary illustration to explain another operation for the play view displayed by the electronic device executing the sound recorder application program.

FIG. 11 is an exemplary view showing index data produced by the electronic device executing the sound recorder application program.

FIG. 12 is an exemplary flowchart showing the procedure of recording processing.

FIG. 13 is an exemplary flowchart showing the procedure of analysis processing.

FIG. 14 is an exemplary flowchart showing the other procedure of analysis processing.

FIG. 15 is an exemplary flowchart showing the procedure of reproducing processing.

### DETAILED DESCRIPTION

Various embodiments will be described hereinafter with reference to the accompanying drawings.

In general, according to one embodiment, an electronic device includes a memory, a microphone, a display and a hardware processor. The hardware processor is configured to: cause the memory to record audio data corresponding-to a sound input via the microphone; produce first images by capturing an image displayed on the display while the audio data is recorded; select second images from the first images, based on variations between images; and display a third image of the second images on a screen of the display if the audio data is reproduced, the third image corresponding to a current reproduction position of the audio data.

The electronic device of the present embodiment can be implemented as, for example, a tablet computer, a smartphone, a personal digital assistant (PDA) or the like. It is assumed here that the electronic device is implemented as a tablet computer 1.

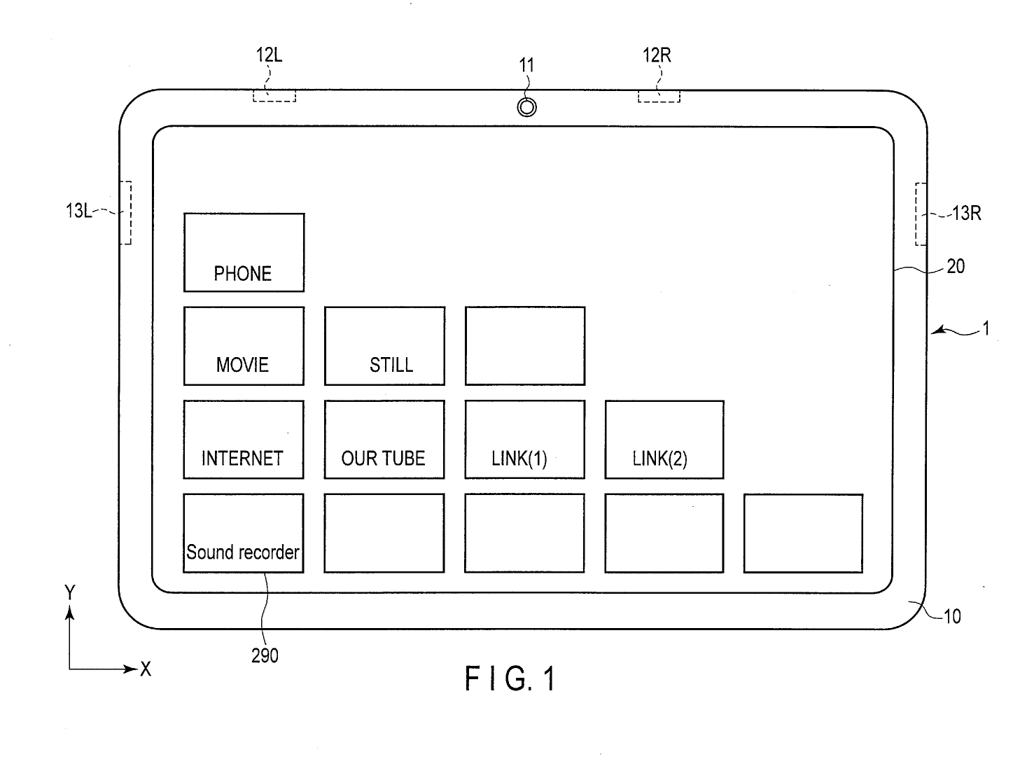

FIG. 1 is an illustration showing an example of an appearance of the tablet computer 1. As shown in FIG. 1, the tablet computer 1 includes a main body 10 and a touchscreen display 20.

A camera (camera unit) 11 is arranged at a predetermined position of the main body 10, for example, a central position at an upper end of a surface of the main body 10. Furthermore, microphones 12R and 12L are arranged at two predetermined positions of the main body 10, for example, two positions remote from each other, at the upper end of the surface of the main body 10. The camera 11 may be arranged between the microphones 12R and 12L. Alternatively, only one microphone may be arranged.

Acoustic speakers 13R and 13L are arranged at two predetermined positions of the main body 10, for example, on a left side surface and a right side surface of the main body 10.

The touchscreen display 20 includes a liquid crystal display (LCD) unit and a touchpanel. The touchpanel is attached on a surface of the main body 10 to cover the LCD screen.

The touchscreen display 20 detects a contact position of an external object (a stylus or a finger) on the screen of the touchscreen display 20. The touchscreen display 20 may support a multi-touch function capable of simultaneously detecting multiple contact positions.

The touchscreen display 20 can display several icons for activating various application programs on the screen. The icons may include an icon 290 to activate a sound recorder application program. The sound recorder application program includes instructions for visualizing a content of voice recorded at a scene such as a conference.

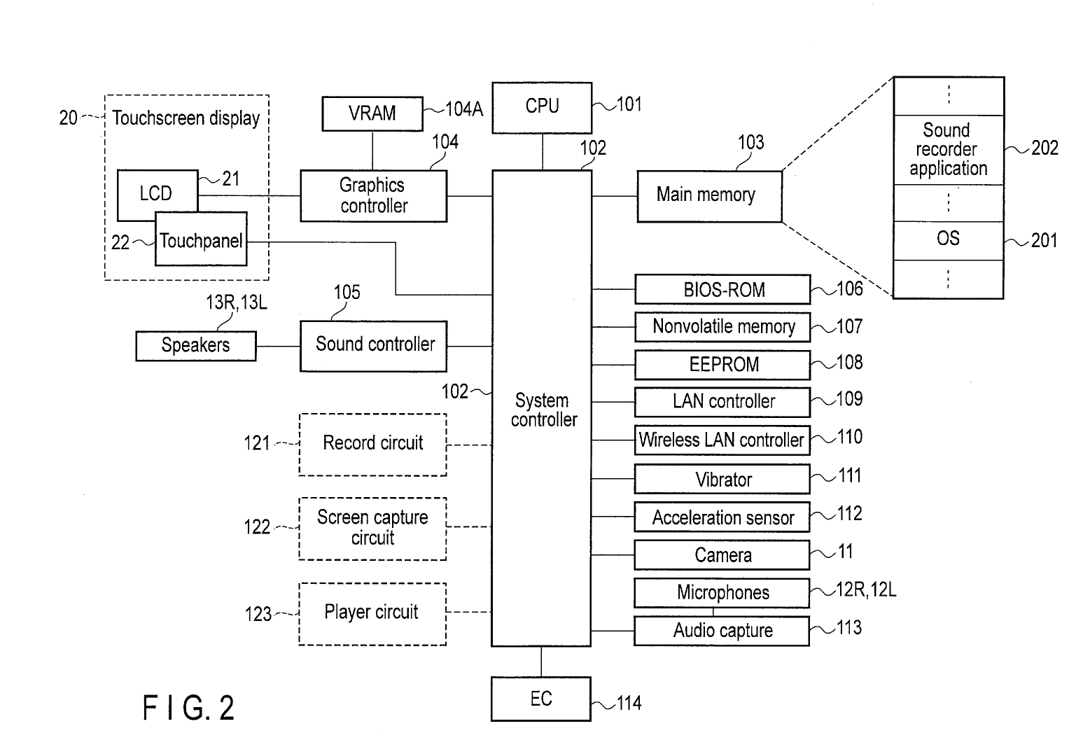

FIG. 2 shows a system configuration of the tablet computer 1.

As shown in FIG. 2, the tablet computer 1 includes a CPU 101, a system controller 102, a main memory 103, a graphics controller 104, a video RAM (VRAM) 104A, a sound controller 105, a BIOS-ROM 106, a nonvolatile memory 107, an EEPROM 108, a LAN controller 109, a wireless LAN controller 110, a vibrator 111, an acceleration sensor 112, an audio capture 113, an embedded controller (EC) 114 and the like.

The CPU 101 is a processor configured to control operations of components in the tablet computer 10. The processor includes a circuit (processing circuit). The CPU 101 executes various programs loaded from the nonvolatile memory 107 to the main memory 103. The programs include an operating system (OS) 201 and various application programs. The application programs include a sound recorder application program 202.

Several characteristics of instructions included in the sound recorder application program 202 will be explained.

The CPU 101 executing the sound recorder application program 202 can record audio data corresponding to sounds input via microphones 12R and 12L.

The CPU 101 executing the sound recorder application program 202 causes the nonvolatile memory 107 to record an image (hereinafter often called a screen capture image) produced by capturing an image displayed on the LCD 21 for, for example, each predetermined time, while recording the audio data. The CPU 101 executing the sound recorder application program 202 deletes redundant images such as sequential similar images from the recorded screen images.

The CPU 101 executing the sound recorder application program 202 performs speaker clustering processing for classifying each of speech sections in a sequence of the audio data into clusters corresponding to speakers in the audio data.

The CPU 101 executing the sound recorder application program 202 performs visualization processing for displaying a display area which represents at least a part of the sequence of the audio data, and screen image which correspond to the sequence. The screen image is the image displayed on the screen of the LCD 21 of the tablet computer 1 recording the audio data in the period in which the audio data is recorded as explained above. It can be therefore presented to the user by the visualization what screen has been displayed at production of the voice (speech).

In addition, the visualization processing includes displaying a speech section for each speaker by using a result of the speaker clustering. It can be thereby presented comprehensibly to the user when and which speaker has made speech.

When the sound recorder application program 202 is used to record, for example, the voice (audio data) at a conference, the sound recorder application program 202 may be executed by any one of a computer used by a presenter, a computer used by a producer of minutes, a computer used by the other participant of the conference and the like.

In the computer 1 used by the presenter, for example, an image of a screen of a reference material such as a screen of PowerPoint (registered trademark) used in the presentation is recorded. In the computer 1 used by the producer of minutes, for example, the screen is shared with the computer 1 used by the presenter of the conference, and the screen image of the reference material used in the presentation is recorded. When the audio data recorded by the computer 1 of the presenter or the producer of the minutes is reproduced, the display area representing the sequence of the audio data and the screen image of the reference material used in the presentation are displayed by the CPU 101 executing the sound recorder application program 202. The user can thereby easily understand what screen image of the reference material has been displayed when the voice is reproduced.

In the computer 1 used by the other participant at the conference, not only the screen image of the reference material used at the presentation, but job screens used at the conference by the user such as a desktop screen or screens of various application programs (for example, a Web browser, a mailer, word processing software and the like) used at the conference by the user are assumed. For this reason, when the audio data recorded by the computer 1 of the other participant at the conference is reproduced, the display area representing the sequence of the audio data and the image of the job screen used in the conference by the user are displayed by the computer 1 executing the sound recorder application program 202. The user can thereby easily understand what job screen has been displayed (i.e., what job the user has executed) when the voice is reproduced.

The sound recorder application program 202 is therefore useful to visualize the audio data recorded at the conference. However, the CPU 101 executing the sound recorder application program 202 can deal with not only the audio data of the conference, but also various types of other audio data, for example, audio data recorded together with the screen image of the computer used by the user for voice chat, video chat, video conference, classes, lecture, and voice (for example, telephone) of customer services.

The instructions included in the sound recorder application program 202 can be incorporated in a circuit such as a processor. Alternatively, the CPU 101 executing the instructions included in the sound recorder application program 202 can also be implemented by dedicated circuits such as a recorder circuit 121, a screen capture circuit 122 and a player circuit 123.

The CPU 101 also executes a basic input-output system (BIOS) stored in the BIOS-ROM 106. The BIOS is a program for hardware control.

The system controller 102 is a device configured to make connection between a local bus of the CPU 101 and each of the components. The system controller 102 incorporates a memory controller which controls access to the main memory 103. In addition, the system controller 102 also has the function of communicating with the graphics controller 104 via a serial bus conforming to the PCI EXPRESS standard.

The system controller 102 also incorporates an ATA controller which controls the nonvolatile memory 107. The system controller 102 further incorporates a USB controller which controls various types of USB devices. The system controller 102 also includes a function to execute communication with the sound controller 105 and the audio capture 113.

The graphics controller 104 is a display controller configured to control the LCD 21 of the touchscreen display 20. The display controller incorporates a circuit (display control circuit). The graphics controller 104 receives data for display of the LCD 21 from the CPU 101 and transfers the data to the VRAM 104A. The graphics controller 104 generates a display signal which is to be supplied to the LCD 21, with data stored in the VRAM 104A. The graphics controller 104 transmits the generated display signal to the LCD 21.

The LCD 21 displays a screen image, based on the display signal. The touchpanel 22 covering the LCD 21 functions as a sensor configured to detect a position of contact between the screen of the LCD 21 and an external object.

The sound controller 105 is a sound source device. The sound controller 105 converts audio data to be reproduced into an analog signal and supplies the analog signal to the acoustic speakers 13R and 13L.

The LAN controller 109 is a wired communication device configured to execute wired communication of, for example, IEEE 802.3 Standard. The LAN controller 109 includes a transmission circuit configured to transmit the signal and a reception circuit configured to receive the signal. The wireless LAN controller 110 is a wireless communication device configured to execute wireless communication of, for example, IEEE 802.11 Standard. The wireless LAN controller 110 includes a transmission circuit configured to transmit the signal in a wireless scheme and a reception circuit configured to receive the signal in a wireless scheme.

The vibrator 111 is a device which produces vibration. The acceleration sensor 112 is employed to detect the current orientation (portrait/landscape) of the main body 10.

The audio capture 113 analog/digital-converts the sound input via the microphones 12R and 12L and outputs a digital signal corresponding to the sound. The audio capture 113 can transmit information indicating which of the microphones 12R and 12L emits the sound of a higher level, to the CPU 101 executing the sound recorder application program 202.

The EC 114 is a single-chip microcomputer including an embedded controller for power management. The EC 114 turns on or off the power of the tablet computer 1 in response to the user operation of the power button.

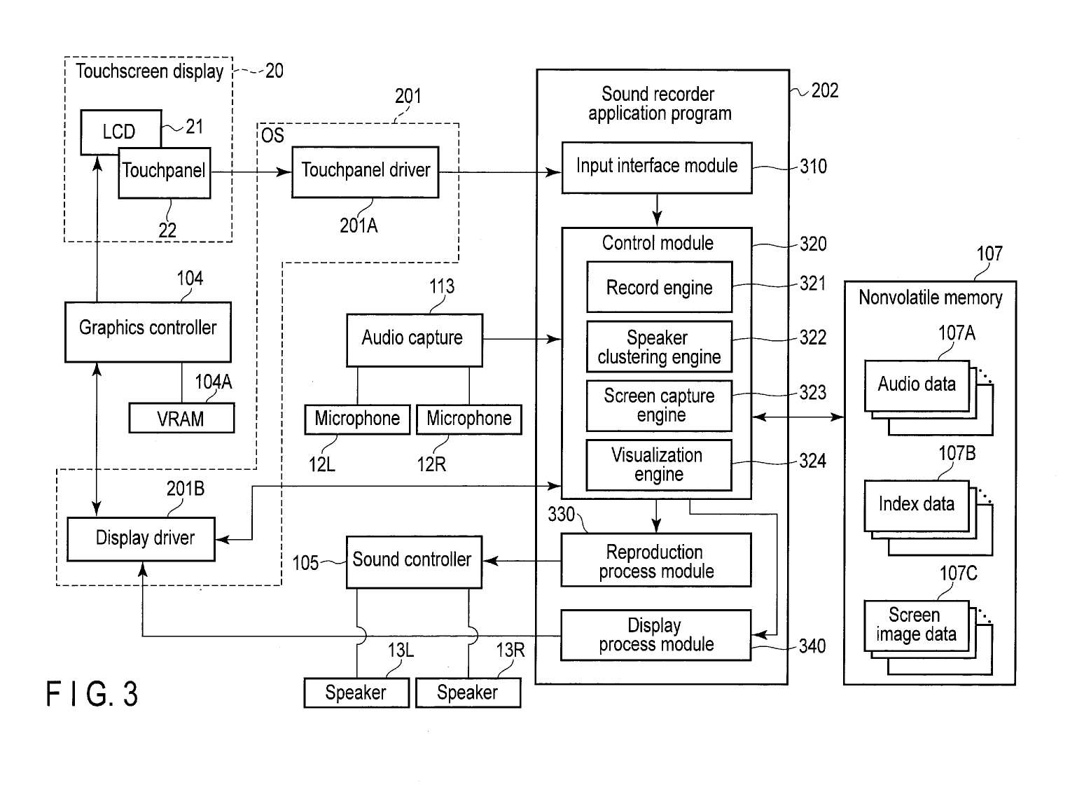

FIG. 3 shows a functional configuration of the sound recorder application program 202.

The sound recorder application program 202 includes an input interface module 310, a control module 320, a reproduction process module 330, and a display process module 340, as functional modules of the program.

The input interface module 310 includes instructions for receiving various events from the touchpanel 22 via a touchpanel driver 201A. The events include a touch event, a move event and a release event. The touch event is an event indicating that an external object has contacted the screen of the LCD 21. The touch event includes coordinates indicating a position of contact between the screen and the external object. The move event is an event indicating that the contact position has been moved while an external object is in contact with the screen. The move event includes coordinates of the contact position of a movement destination. The release event is an event indicating that the contact between the external object and the screen has been released. The release event includes coordinates of the release position at which the contact has been released.

The control module 320 includes instructions for detecting what finger gesture (tap, double-tap, tap and hold, swipe, pan, pinch, stretch or the like) has been executed and at which part of the screen the finger gesture has been executed, based on various events received from the input interface module 310. The control module 320 includes a recording engine 321, a speaker clustering engine 322, a screen capture engine 323, a visualization engine 324 and the like.

The recording engine 321 includes instructions for causing the nonvolatile memory 107 to record the audio data 107A corresponding to the sound input via the microphones 12R and 12L and the audio capture 113. The audio data 107A is recorded in various scenes such as a conference, a telephone conversation, and a presentation. The recording engine 321 also includes instructions for recording of other types of audio sources such as broadcasting, music and the like.

The speaker clustering engine 322 includes instructions for analyzing the audio data 107A (recorded data) and identifying a speaker (or speakers). The speaker clustering engine 322 executed by the CPU 101, which speaker has made speech and when the speaker has made the speech are detected. The speaker is identified for each data sample having a time length of, for example, 0.5 seconds. In other words, the sequence of the audio data 107A, i.e., a signal sequence of the digital audio signals is processed for each sound data unit having a time length of 0.5 seconds (i.e., a set of audio data samples for 0.5 seconds). That is, the speaker clustering engine 322 includes instructions for identifying a speaker for each sound data unit.

The speaker clustering engine 322 may include instructions for detecting speech and clustering speaker though not limited. The instructions for detecting speech includes instructions for detecting whether each sound data unit is a speech (voice) section or a non-speech section (noise section or silent section) other than the speech section. The instructions for detecting speech may be implemented based on, for example, voice activity detection (VAD). The CPU 101 may execute the speaker clustering engine 322 in real time during the sound recording.

The instructions for clustering speaker include instructions for identifying which speaker has made the speech in the sequence, in each speech section included in the sequence from the start point to the end point of the audio data. In other words, the instructions for clustering speaker include instructions for classifying speech sections into clusters corresponding to speakers in the audio data, respectively. Each cluster is a set of sound data units corresponding to the speech made by a certain speaker.

Various existing methods can be applied to the instructions for clustering speaker. In the present embodiment, both a method of speaker clustering using a speaker position and a method of speaker clustering using a speech feature (acoustic feature) may be applied, though not limited.

The speaker position indicates a position of each speaker with respect to the tablet computer 1. The speaker position can be estimated based on the difference between two sound signals input via the two microphones 12R and 12L. Speeches input from the same speaker position are estimated to be speeches of the same speaker.

In the method of speaker clustering using the speech feature, sound data units having features similar to each other are classified into the same cluster (the same speaker). The speaker clustering engine 322 includes instructions for extracting the feature such as Mel Frequency Cepstrum Coefficient (MFCC) from each sound data unit determined as the speech. The speaker clustering engine 322 includes instructions for clustering a speaker by considering not only the speaker position of each sound data unit, but also the feature of each sound data unit.

Information indicating a result of the speaker clustering is saved on the nonvolatile memory 107 as index data 107B.

The screen capture engine 323 includes instructions for causing the nonvolatile memory 107 to store screen image data 107C produced by capturing the image displayed on the LCD 21. The screen capture engine 323 includes instructions for capturing data stored in the VRAM 104A via a display driver 201B and the graphics controller 104 and producing screen images (image data) 107C by using the captured data.

The screen capture engine 323 includes instructions for producing screen images (hereinafter also called first images) 107C during a period of recording the audio data 107A. The first images 107C are produced by capturing the images displayed on the screen for each constant time (for example, 10 seconds, 30 seconds or the like) while the audio data 107A is recorded. The screen capture engine 323 includes instructions for causing the nonvolatile memory 107 to store the screen image 107C to which a time stamp indicating a production time (date and time of the production) is added.

Incidentally, the nonvolatile memory 107 is assumed to store a large number of screen images 107C during a period of recording the audio data. For example, if the screen images are produced for each 10 seconds during a period of recording 2-hour audio data, the nonvolatile memory 107 stores 720 screen images.

The stored screen images 107C may include images produced for, for example, several minutes, i.e., a period in which the same screen or a rarely changed screen has been displayed. Images on the same screen or the rarely changed screen may be redundant as triggers for indicating the reproduction position of the audio data.

In addition, an area where the screen images are displayed is limited at the audio data reproduction. For this reason, displaying a large number of screen images on the screen is difficult and, if a large number of screen images are displayed, a display size of the images may become smaller or the images may be superposed. In this case, visibility of the images becomes deteriorated, and the user operation for selecting an image to indicate the voice reproduction position also becomes difficult.

Thus, the screen capture engine 323 includes instructions for selecting screen images (hereinafter also called second images) displayed at reproduction of the recorded audio data 107A and deleting redundant screen images in the first images. The screen capture engine 323 includes instructions for selecting the second images from the first images produced during recording the audio data 107A based on, for example, a variation between two images. For example, the second images can be obtained by deleting (thinning) either of two images in the first images in case where a variation between the two images is smaller than or equal to a threshold value. In other words, the images finally left by executing the processing of deleting an image of a small variation between images, in the first images, are the second images that can be displayed at the reproduction of the audio data 107A.

The second images are displayed on the screen when the recorded audio data 107A is reproduced as explained later, and are used as triggers for indicating the reproduction position of the audio data 107A. By the operation for selecting the displayed image, the user can indicate the reproduction of the audio data 107A at the position corresponding to the time at which the image is produced.

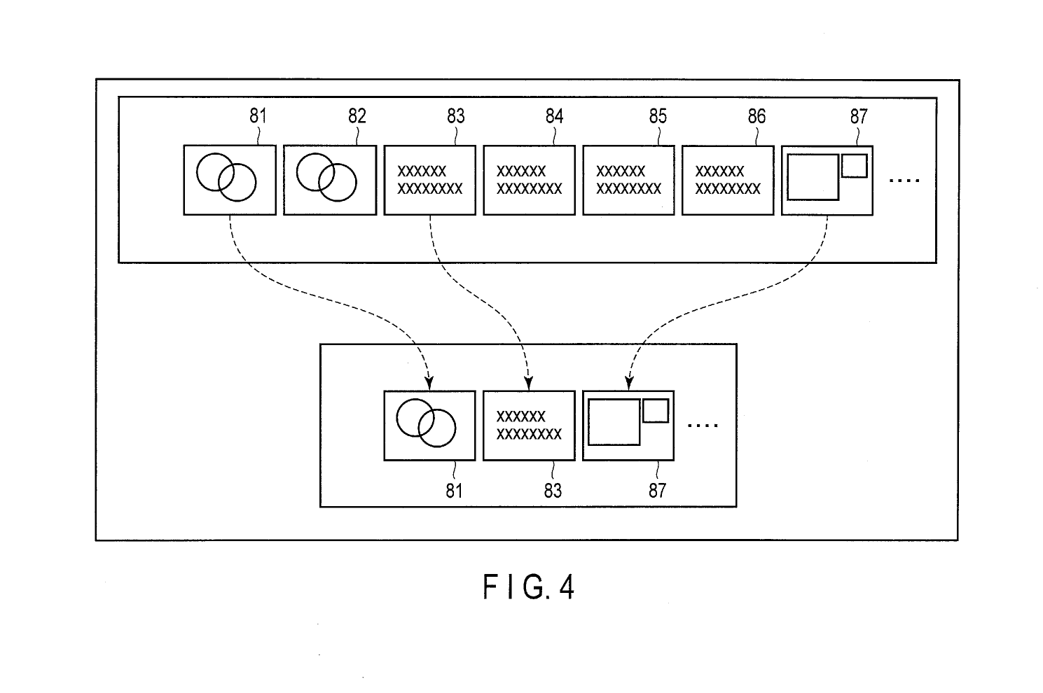

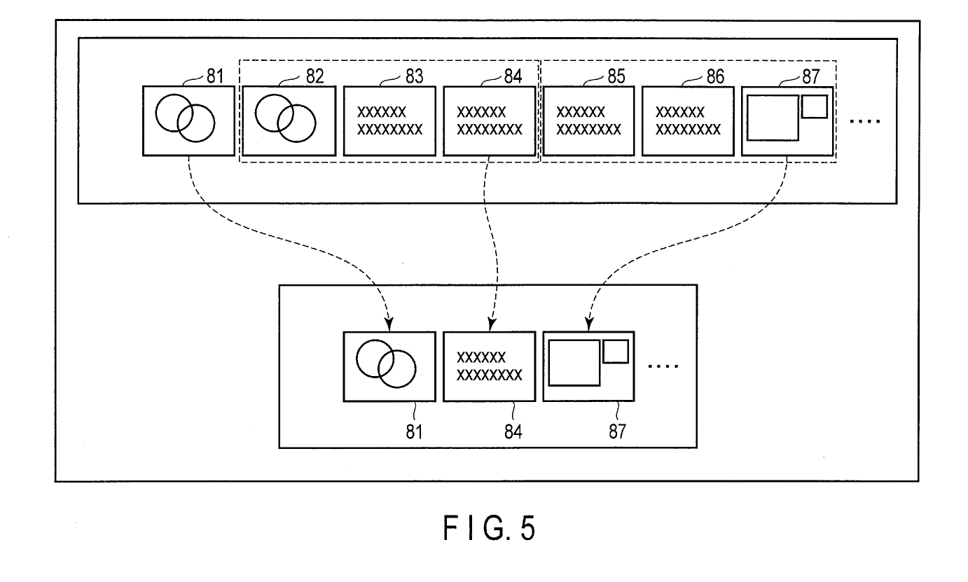

Two examples of analysis (thinning) to delete redundant images in screen images (first images) produced during the recording will be explained with reference to FIG. 4 and FIG. 5.

In the analysis processing shown in FIG. 4, when a variation between two images of the first images is small (for example, a variation between the two images is smaller than a threshold value), the two images are estimated to be similar to each other and judged to be redundant as the images in which the contents of the recorded audio data 107A can be recognized, and either of the images is deleted. It is hereinafter assumed that screen images 81 to 87 (first images) in order of production time as produced during the recording are subjected to the analysis processing.

A sum of differences in pixel values of corresponding pixels is calculated, between the screen image 81 and the screen image 82. Since the calculated sum is smaller than the threshold value, the screen image 81 is determined as an image which is displayed at the reproduction of the audio data 107A, and the screen image 82 is deleted.

Next, a sum of differences in pixel values of corresponding pixels is calculated, between the determined screen image 81 and the subsequent screen image 83. Since the calculated sum is greater than or equal to the threshold value, the screen image 83 is determined as the image which is displayed at the reproduction of the audio data 107A.

Furthermore, a sum of differences in pixel values of corresponding pixels is calculated, between the determined screen image 83 and the subsequent screen image 84. Since the calculated sum is smaller than the threshold value, the screen image 84 is deleted.

Similarly, the screen image 85 and the screen image 86 are deleted, and the screen image 87 is determined as the image which is displayed at the reproduction of the audio data 107A.

As a result of the analysis processing, the screen images 81, 83 and 87 (second images) which are displayed at reproduction of the audio data 107A can be selected from the screen images 81 to 87 produced during the recording.

The analysis processing shown in FIG. 5 may be executed instead of the analysis processing shown in FIG. 4. In the analysis processing shown in FIG. 5, one criterion image and a plurality of (for example, three) reference images subsequent to the criterion image, of the first images in order of production time are used, and a reference image having a most different feature from the criterion image, of the reference images, is determined to be useful to recognize the contents of the recorded audio data 107A. In the analysis processing, the reference images other than the reference image determined to be useful are deleted. It is hereinafter assumed that screen images 81 to 87 (first images) in order of production time as produced during the recording are subjected to the analysis processing.

First, the leading screen image 81 is set as the criterion image, and a plurality of (three, in the present example) screen images 82, 83 and 84 subsequent to the criterion image 81 are set as the reference images. Features of the criterion image 81 and the reference images 82, 83 and 84 are calculated respectively. The feature is calculated with the pixel values in the image and indicates, for example, an edge, a corner and the like in the image. The feature may be a feature of the whole screen image or a feature of a partial area in the screen image (for example, an area of a predetermined size located in the center of the screen image).

The reference image 84 having a smallest similarity to the criterion image 81, of the reference images 82, 83 and 84, is determined as the image which is displayed at the reproduction of the audio data 107A, based on the calculated features. In other words, the reference image 84 having a most different feature from the criterion image 81 is determined as the image which is displayed at the reproduction of the audio data 107A. The reference images 82 and 83 other than the determined reference image 84 are deleted from the nonvolatile memory 107.

Next, the reference image 84 is set as a new criterion image, and the screen images 85, 86 and 87 subsequent to the criterion image 84 are set as new reference images. Features of the criterion image 84 and the reference images 85, 86 and 87 are calculated respectively. The feature calculated when the criterion image 84 has been set as the reference image may be used as the feature of the criterion image 84.

The reference image 87 having a smallest similarity to the criterion image 84, of the reference images 85, 86 and 87, is determined as the image which is displayed at the reproduction of the audio data 107A, based on the calculated features. In other words, the reference image 87 having a most different feature from the criterion image 84 is determined as the image which is displayed at the reproduction of the audio data 107A. The reference images 85 and 86 other than the determined reference image 87 are deleted from the nonvolatile memory 107.

As a result of the analysis processing, the screen images 81, 84 and 87 (second images) which are displayed at reproduction of the audio data 107A can be selected from the screen images 81 to 87 produced during the recording.

The reproduction process module 330 includes instructions for reproducing the audio data 107A (voice). More specifically, the reproduction process module 330 includes instructions for outputting the audio data 107A which is a reproduction target, to the sound controller 105. The reproduction process module 330 includes instructions for controlling data at a portion which is a reproduction target in the audio data 107A to be output to the sound controller 105 to change the reproduction position of the audio data 107A to an arbitrary position.

The visualization engine 324 includes instructions for visualizing an outline of a sequence of the audio data 107A in cooperation with instructions included in the display process module 340. More specifically, the visualization engine 324 includes instructions for displaying, when the audio data 107A is reproduced, a screen image (hereinafter called a third image) corresponding to the current reproduction position of the audio data 107A, of the screen images (i.e., the second images) selected based on the variations between images, from the screen images (i.e., the first images) produced during the recording of the audio data 107A.

The visualization engine 324 includes instructions for determining, when the audio data 107A is reproduced, whether the screen images (image data 107C) associated with the audio data 107A is present or not, based on, for example, the index data 107B. The visualization engine 324 includes instructions for reading screen images (image data 107C) each having a time stamp within a period from the time when the recording of the reproduced audio data 107A is started until the time when the recording is ended, from the nonvolatile memory 107. The visualization engine 324 includes instructions for arranging, if the screen images associated with the audio data 107A is present (i.e., if the screen images each having a time stamp within a period from the time when the recording of the reproduced audio data 107A is started until the time when the recording is ended, is present), the screen images in a reproduction screen (play view).

A leading screen image of the screen images (i.e., the second images) associated with the audio data 107A is, for example, an image produced when the recording of the audio data 107A is started. The visualization engine 324 includes instructions for displaying, if the audio data 107A is reproduced from a leading part, the leading screen image on the screen. The visualization engine 324 includes instructions for sequentially changing the displayed screen image to a screen image produced at a time corresponding to the reproduction position (i.e., a screen image to which time stamp of a time corresponding to the reproduction position is added), in accordance with progress of the voice reproduction.

The visualization engine 324 includes instructions for displaying an image subsequent to the displayed third image, of the second images in order of reproduction time, in accordance with an operation for changing the third image to the subsequent image (for example, an operation for tapping a button to direct changing to a subsequent image). In addition, the visualization engine 324 includes instructions for displaying an image preceding the third image, of the second images in order of reproduction time, in accordance with an operation for changing the displayed third image to a previous image (for example, an operation for tapping a button to direct changing the image to a previous image).

The reproduction process module 330 includes instructions for changing, in accordance with an operation for selecting the displayed image (for example, an operation for tapping the displayed image), the current reproduction position of the audio data 107A to a position corresponding to a time when the selected image is produced, i.e., jumping to a leading part of a section to which the selected image is allocated.

In addition, the visualization engine 324 includes instructions for displaying the display area representing the sequence of the audio data 107A, and displaying the screen images at positions based on a time allocated to the display area and the time at which each of the screen images (i.e., the second images) associated with the audio data 107A is produced. The reproduction process module 330 includes instructions for changing, in accordance with an operation for selecting one of the screen images displayed, the current reproduction position of the audio data 107A to a position corresponding to the time when the selected image is produced.

Furthermore, the visualization engine 324 may include instructions for displaying speech sections in a manner in which speakers of the respective speech sections can be identified. More specifically, the visualization engine 324 includes instructions for displaying a display area representing the whole sequence. The visualization engine 324 further includes instructions for displaying each speech section on the display area in the manner in which the speakers of the respective speech sections can be identified.

Next, several views (home view, recording view, and play view) displayed on the screen by the CPU 101 executing the sound recorder application program 202 will be explained.

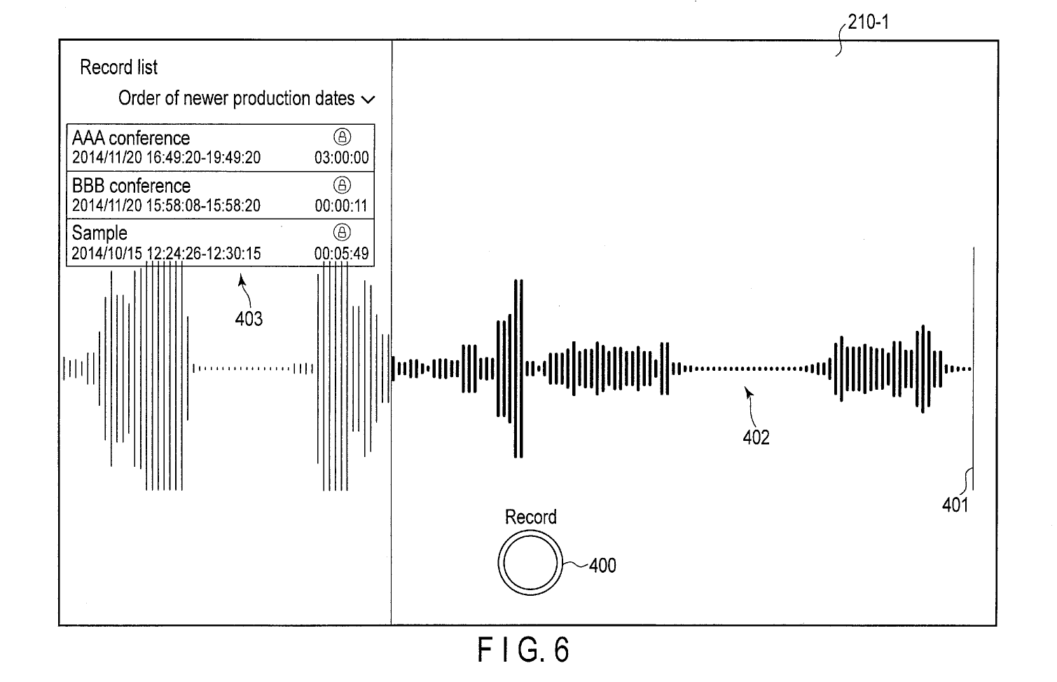

FIG. 6 shows the home view 210-1.

When the sound recorder application program 202 is activated, the home view 210-1 is displayed.

As shown in FIG. 6, a record button 400, a sound waveform 402, and a record list 403 are displayed in the home view 210-1. The record button 400 is a button for a command to start the recording.

The sound waveform 402 represents a waveform of a sound signal currently input via the microphones 12R and 12L. The waveforms of sound signals appear successively from a vertical bar 401. Then, the waveforms of the sound signals move leftward from the vertical bar 401 as the time elapses. The waveforms of the sound signals constituting the sound waveform 402 are represented by successive vertical bars. The successive vertical bars have lengths corresponding to power of respective successive sound signal samples. The user can confirm whether sounds have been normally input or not, before starting the recording, by the display of the sound waveform 402.

The record list 403 represents a list of records. Each record is stored in the nonvolatile memory 107 as the audio data 107A. It is assumed here that there are three records, i.e., a record titled “AAA conference”, a record titled “BBB conference”, and a record titled “Sample”.

In the record list 403, a recording date, a recording start time and recording end time, and a length of each record are also displayed. In the record list 403, recordings (records) can be sorted in order of newer production dates or older production dates.

When a certain record in the record list 403 is selected by the user's tap operation, reproducing the selected record is started.

In accordance with the user operation for tapping the record button 400, the recording is started.

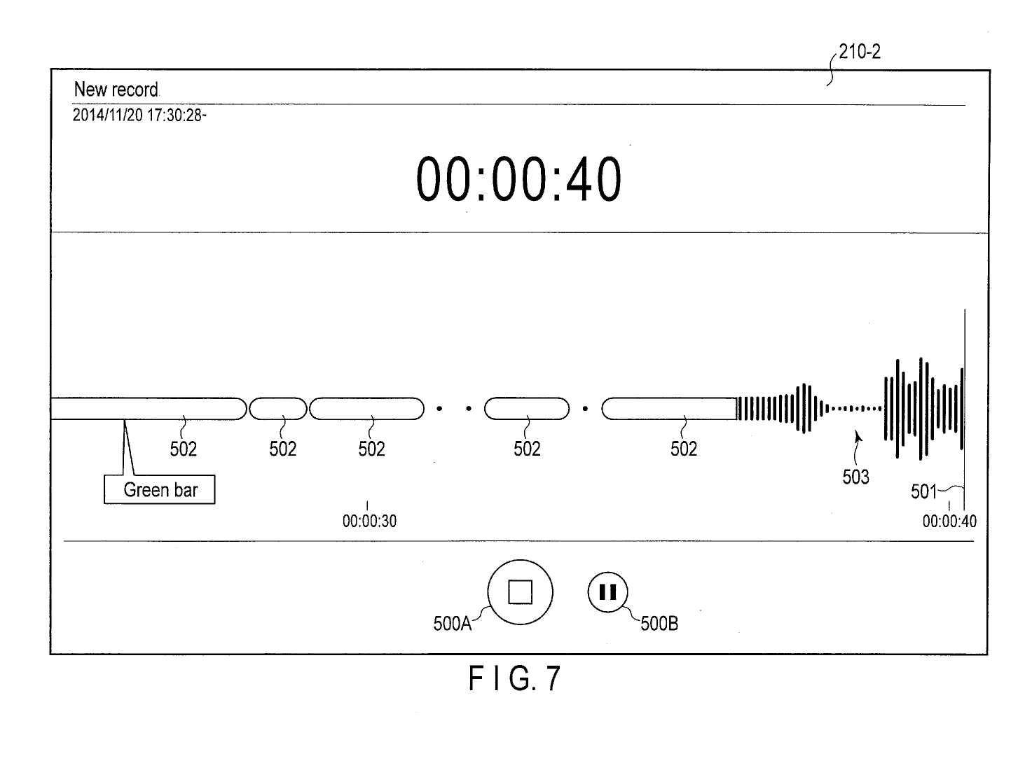

FIG. 7 shows the recording view 210-2.

When the user taps the record button 400 of the home view 210-1, recording is started, and the display screen is changed from the home view 210-1 shown in FIG. 6 to the recording view 210-2 shown in FIG. 7.

In the recording view 210-2, a stop button 500A, a pause button 500B, a speech section bar (green) 502, and a sound waveform 503 are displayed. The stop button 500A is a button for stopping the current recording. The pause button 500B is a button for pausing the current recording.

The sound waveform 503 represents a waveform of a sound signal currently input via the microphones 12R and 12L. The waveforms of the sound signals appear successively from a vertical bar 501 and move leftward as the time elapses. The waveforms of the sound signals constituting the sound waveform 503 are represented by a number of vertical bars having lengths corresponding to the power of sound signals.

The above-explained speech detection is executed during the recording. If at least one sound data unit in the sound signals is detected as speech (human voice), the speech section corresponding to the at least one sound data unit is visualized by the speech section bar (for example, green) 502. The length of each speech section bar 502 varies according to the time length of the corresponding speech section.

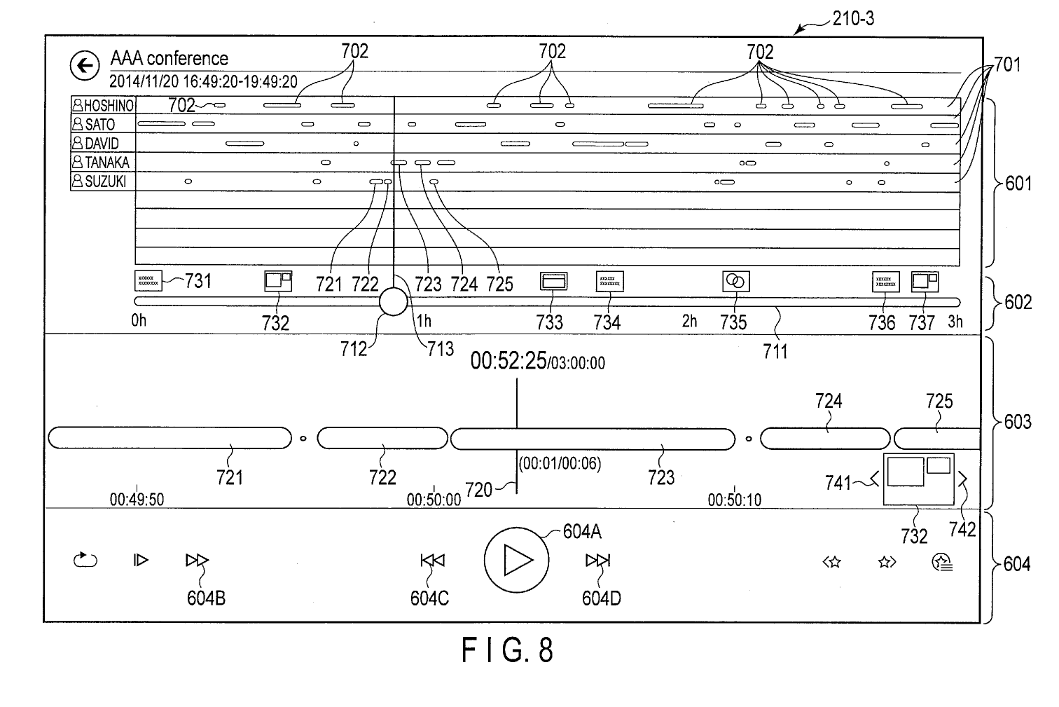

FIG. 8 shows the play view 210-3. When the user taps a certain record in the record list 403 of the home view 210-1, reproduction of the selected record (audio data 107A) is started, and the display screen is changed from the home view 210-1 shown in FIG. 6 to the play view 210-3 shown in FIG. 8.

It should be noted that the play view 210-3 in FIG. 8 shows a status in which the reproduction is paused during the reproduction of the record (audio data 107A) titled “AAA conference”. As shown in FIG. 8, the play view 210-3 includes a speaker view area 601, a seek bar area 602, a play view area 603, and a control panel 604.

In the control panel 604, several buttons to control reproduction of the records are displayed. In the control panel 604, for example, a reproduction button 604A for reproducing (resuming) the paused record, a button 604B for fast-forwarding a record, a button 604C for changing the record to be reproduced to a previous record, a button 604D for changing the record to be reproduced to a next record, and the like are displayed. When the record is being reproduced, a stop button for stopping the reproduction of the record and a pause button for pausing the reproduction of the record may be displayed instead of the reproduction button 604A, in the control panel 604.

The speaker view area 601 is a display area displaying the whole sequence of the record titled “AAA conference”. In the speaker view area 601, time bars (also referred to as time lines) 701 corresponding to respective speakers in the sequence of the record may be displayed. In this case, in a sequence of the record including five speakers, five time bars 701 corresponding to respective five speakers are displayed. For example, ten speakers can be identified at maximum per record and ten time bars 701 can be displayed at maximum per record.

In the speaker view area 601, five speakers are arranged in order of greater amount of speech in the whole sequence of the record titled “AAA conference”. A speaker having a greatest amount of speech in the whole sequence is displayed on the top of the speaker view area 601.

Each time bar 701 is a display area extending in the direction of the time axis (in this case, horizontal direction). The left end of each time bar 701 corresponds to a start time of the sequence of the record, and the right end of each time bar 701 corresponds to an end time of the sequence of the record. In other words, the total time from the start to the end of the sequence of the record is allocated to each time bar 701.

On the left side of the time bars 701, human body icons and speaker names (“HOSHINO”, “SATO”, “DAVID”, “TANAKA”, and “SUZUKI”) are displayed. The speaker names are, for example, information added by a user edition operation. The speaker names are not displayed in an initial status before the user edition operation is executed. Alternatively, symbols such as “A”, “B”, “C”, “D”, . . . may be displayed beside the human body icons instead of the speaker names, in the initial status.

On the time bar 701 of a certain speaker, a speech section bar indicating the position and the time length of each speech section of the speaker is displayed. Different colors may be allocated to the speakers, respectively. In this case, speech section bars in different colors may be displayed for the respective speakers. For example, a speech section bar 702 in the time bar 701 of speaker “HOSHINO” may be displayed in the color (for example, red) allocated to speaker “HOSHINO”.

By tapping an arbitrary position on the time bar 701 corresponding to an arbitrary speaker, the user can change the current reproduction position to a position corresponding to the tapped position. For example, if a certain position on a certain time bar 701 is tapped, the current reproduction position may be changed to the position.

By sequentially tapping speech sections (speech section bars) of a specific speaker, the user can listen to the speech sections of the specific speaker.

In the seek bar area 602, a seek bar 711, a movable slider (also referred to as a locater) 712, a vertical bar 713, and screen images 731 to 737 are displayed. The total time from the start to the end of the sequence of the record is allocated to the seek bar 711. The position of the slider 712 on the seek bar 711 indicates the current reproduction position. The vertical bar 713 extends upwardly from the slider 712. Since the vertical bar 713 traverses the speaker view area 601, the user can easily understand which speaker's (main speaker's) speech section includes the current reproduction position.

The position of the slider 712 on the seek bar 711 moves rightward as the reproduction progresses. The user can move the slider 712 rightward or leftward by a drag (swipe) operation. The user can thereby change the current reproduction position to an arbitrary position.

The screen images 731 to 737 are arranged at positions adjacent to the seek bar 711 (in the present example, at an upper portion of the seek bar 711). More specifically, the screen images 731 to 737 are arranged at positions corresponding to times at which the screen images 731 to 737 are produced, with respect to the time represented by the seek bar 711 (i.e., the time from the start to the end of the audio data 107A). Therefore, correspondence between the sequence of the audio data 107A and the screen displayed during the recording can be presented comprehensibly to the user.

By tapping any one of the screen images 731 to 737, the user can change the current reproduction position to a position corresponding to the time at which the tapped screen image is produced. Therefore, in response to a user request that the user wishes to listen to the voice at the time of displaying the screen, using the screen images 731 to 737, the audio data 107A can be reproduced from the position corresponding to the screen.

In the play view area 603, an enlarged view of a period near the current reproduction position (for example, a period of approximately twenty seconds) is displayed. The play view area 603 includes a display area extending in the direction of the time axis (in this case, horizontal direction). In the play view area 603, several speech sections included in the period near the current reproduction position are displayed in chronological order. A vertical bar 720 indicates the current reproduction position.

The vertical bar 720 is displayed at a position of center between the left end and the right end of the play view area 603. The position of the vertical bar 720 is fixed. Several speech section bars on the play view area 602 or speech section bars 721, 722, 723, 724 and 725 in the present example are scrolled from the right to the left as the reproduction progresses.

When the user flicks (swipes) the play view area 603 leftward or rightward, the speech section bars 721, 722, 723, 724 and 725 in the play view area 603 are scrolled leftward or rightward in a status in which the position of the vertical bar 720 is fixed. Consequently, the current reproduction position is changed.

A screen image 732 and buttons 741 and 742 are further displayed in the play view area 603. The screen image 732 is an image corresponding to the current reproduction position (for example, an image of the screen displayed when the voice at the current reproduction position is recoded), of the screen images 731 to 737 corresponding to the audio data 107A which is being reproduced. The button 741 is used to direct displaying an image previous to the screen image 732. The button 742 is used to direct displaying an image subsequent to the screen image 732.

The screen image 732 displayed in the play view area 603 is changed as the reproduction progresses. For example, the screen image 732 is displayed in the play view area 603 in a period from the time when the position corresponding to the production time of the screen image 732 is reproduced to the time immediately before the position corresponding to the production time of a subsequent screen image 732 is reproduced. The screen image 732 is changed to the screen image 733 at the time when the position corresponding to the production time of the screen image 733 is reproduced. In other words, a display period from the time when the position corresponding to the production time of the screen image 732 is reproduced to the time immediately before the position corresponding to the production time of the subsequent screen image 733 is reproduced is allocated to the screen image 732. In response to the user's tap of the screen image 732 displayed in the play view area 603, the current reproduction position may be changed (jumped) to the position corresponding to the time when the screen image 732 is produced (i.e., a leading part of the display period allocated to the screen image 732).

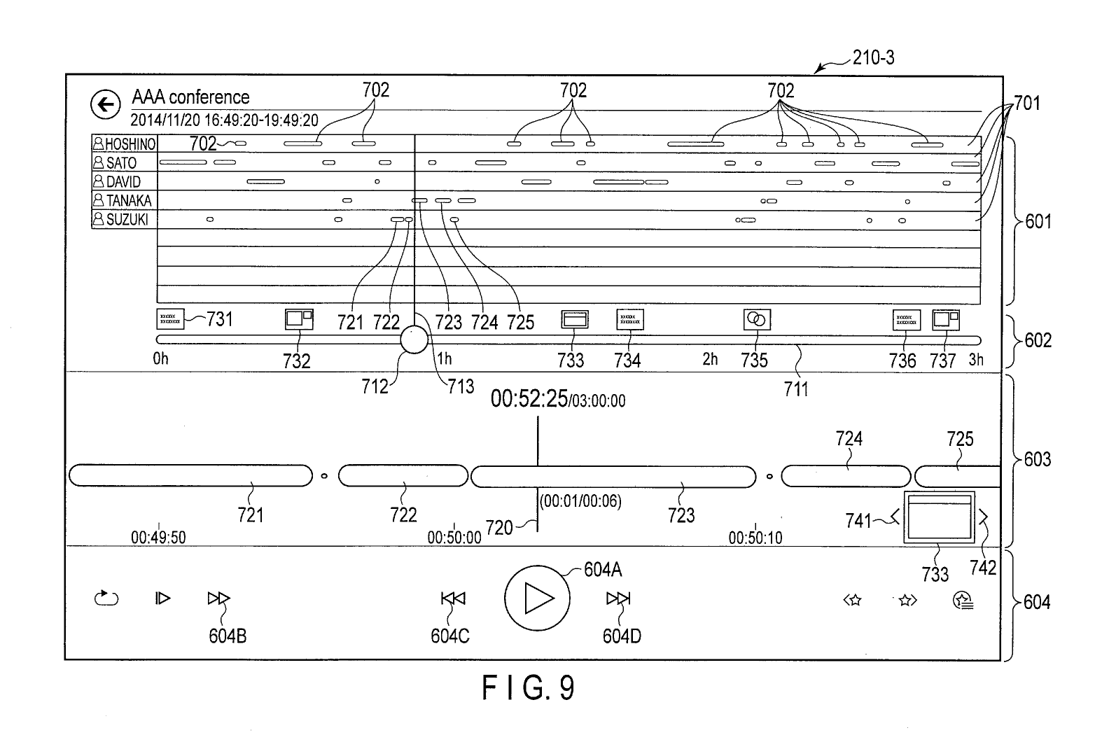

In addition, the screen image 732 displayed in the play view area 603 can also be changed in response to the user operation for tapping the button 741 or the button 742. In response to the user operation for tapping the button 741 to direct displaying the previous screen image, the screen image 732 in the play view area 603 is changed to the previous screen image 731. In addition, in response to the user operation for tapping the button 742 to direct displaying the subsequent screen image, the screen image 732 in the play view area 603 is changed to the subsequent screen image 733 as shown in FIG. 9.

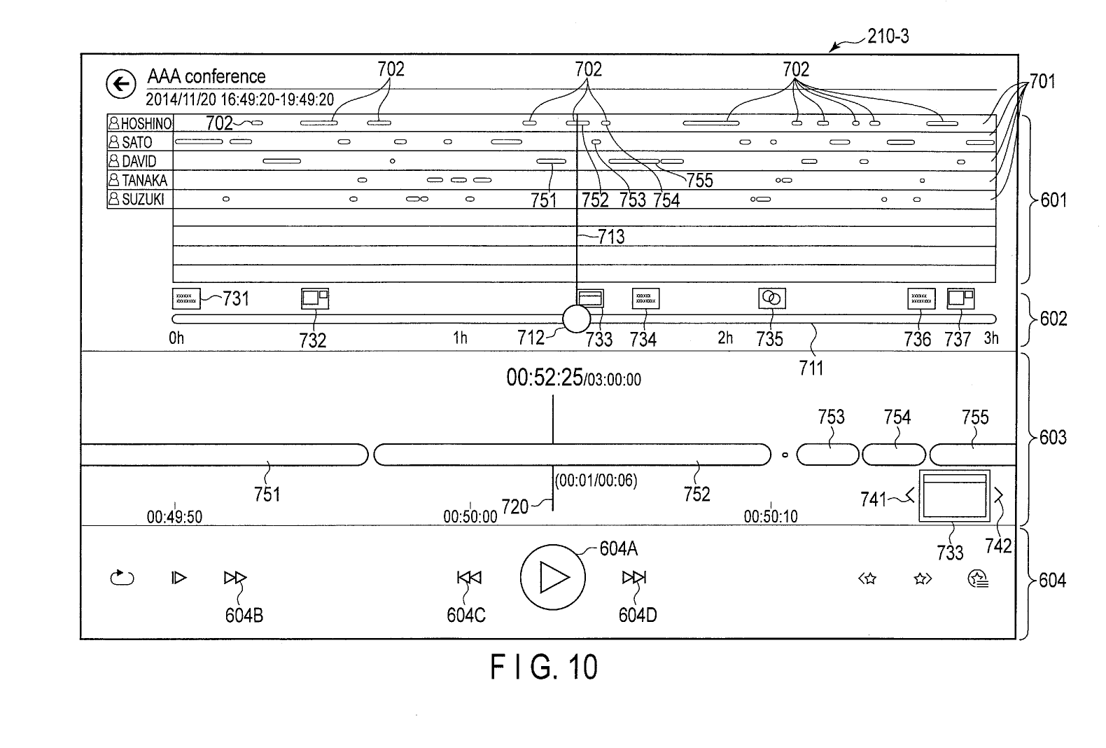

Furthermore, as shown in FIG. 10, in response to the user operation for tapping the screen image 733, the current reproduction position can also be changed (jumped) to the position corresponding to the time when the screen image 733 is produced (i.e., a leading part of the display period allocated to the screen image 733). In response to this, the slider 712 on the seek bar 711 and the vertical bar 713 are displayed at the changed current reproduction position. In addition, speech section bars 751, 752, 753, 754 and 755 included in the period near the changed current reproduction position are displayed in the play view area 603.

The user can therefore change the screen image displayed in the play view area 603 by the operation for tapping the button 741 or 742, and can change the reproduction position of the audio data 107A to the position corresponding to the changed screen image by the operation for tapping the changed screen image.

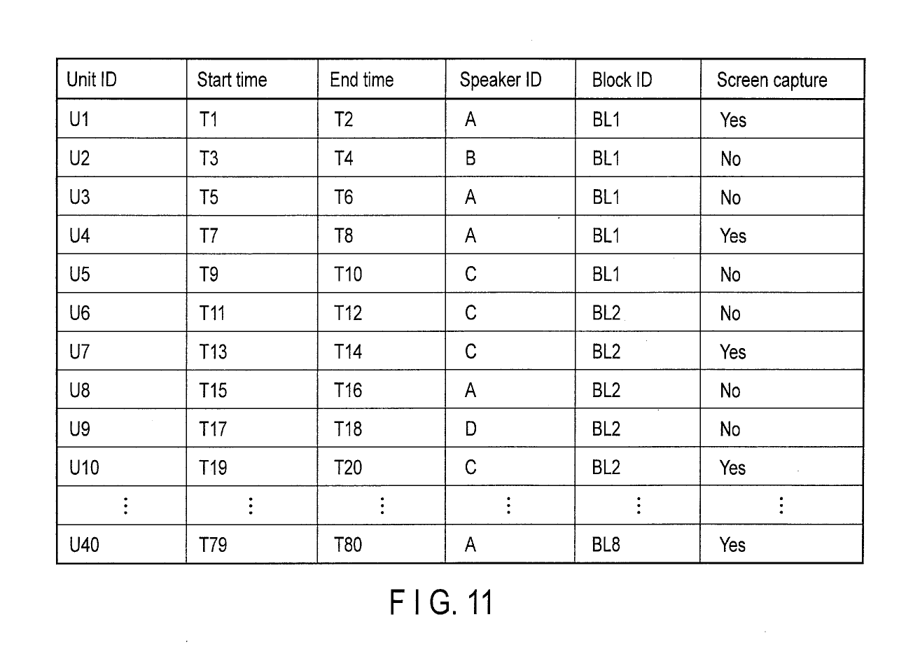

FIG. 11 shows an example of the index data 107B used by the CPU 101 executing the sound recorder application program 202.

A table of the index data 107B includes storage areas corresponding to voice data units. Each of the storage areas includes a “unit ID” field, a “start time” field, an “end time” field, a “speaker ID” field, a “block ID” field, and a “screen capture” field. An ID allocated to the corresponding voice data unit is stored in the “unit ID” field. A start time of the corresponding voice data unit is stored in the “start time” field. An end time of the corresponding voice data unit is stored in the “end time” field. An ID allocated to the speaker corresponding to the corresponding voice data unit is stored in the “speaker ID” field. An ID of the block to which the corresponding voice data unit belongs is stored in the “block ID” field. A value indicating whether the image displayed in the screen is captured or not, during a period of the corresponding voice data unit, (for example, “yes” or “no”) is stored in the “screen capture” field.

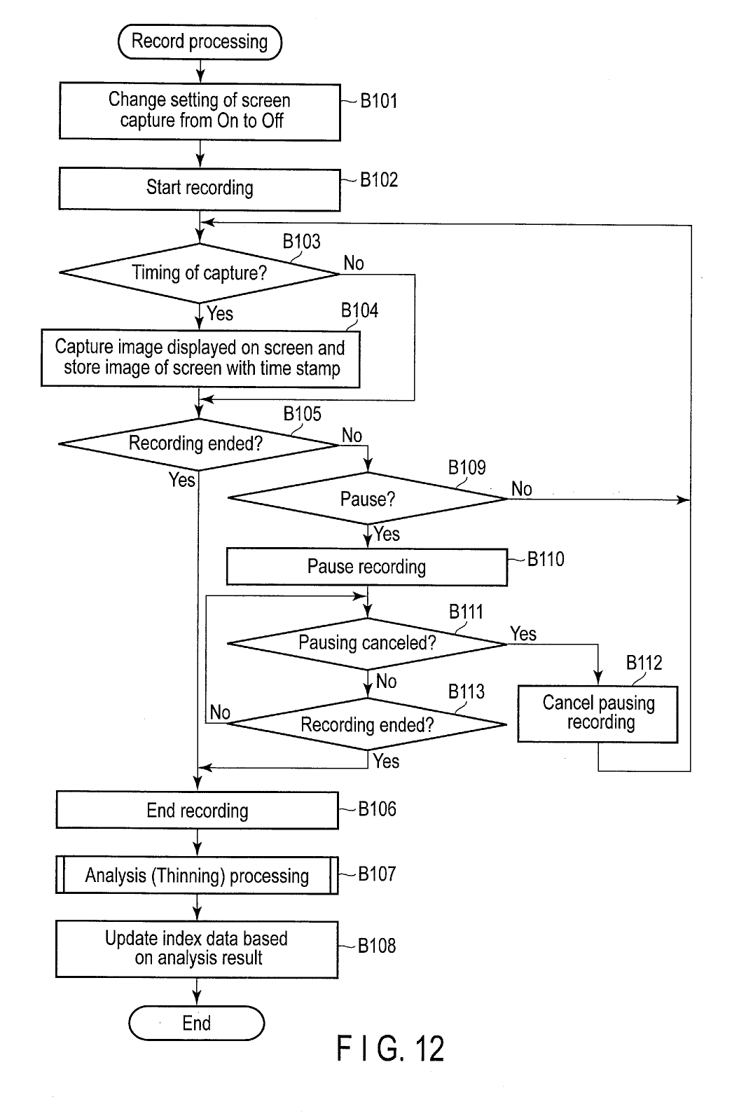

Next, an example of the procedure of record processing for recording the audio data and the screen images performed by the tablet computer 1 will be explained with reference to a flowchart of FIG. 12. As described above, the CPU 101 of the tablet computer 1 executes the instructions included in the sound recorder application program 202.

The setting of the screen capture during the recording is changed from OFF to ON (block B101). The setting indicating whether the screen capture is executed during the recording or not is changed from ON to OFF, in response to the user operation for, for example, tapping the button to direct setting the screen capture on the setting screen (not shown) to ON.

Then, recording is started (block B102). Recording is started in response to the operation that, for example, the user taps the record button 400 on the home view 210-1.

It is determined whether the timing of capturing the image displayed on the screen appears or not during the recording (block B103). It is determined that the timing of capturing the image displayed on the screen appears, for example, when the recording is started and when a certain period has elapsed after capturing the previous image displayed on the screen.

If the timing of capturing the image displayed on the screen appears (Yes in block B103), the image is produced by capturing the image displayed on the LCD 21, a time stamp indicating the production date and time is added to the image, and the image is stored in the nonvolatile memory 107 or the like (block B104). If the timing of capturing the image displayed on the screen does not appear (No in block B103), the procedure of block B104 is skipped.

Then, it is determined whether the recording should be ended or not (block B105). For example, if the stop button 500A on the recording view 210-2 is tapped, it is determined that the recording should be ended.

If it is determined that the recording should not be ended (No in block B105), it is determined whether the recording should be paused or not (block B109). For example, if the pause button 500B on the recording view 210-2 is tapped, it is determined that the recording should be paused. If the pause button 500B is tapped, a recording button (not shown) for resuming the recording may be displayed instead of the pause button 500B.

If it is determined that the recording should be paused (Yes in block B109), the recording is paused (block B110). Then, it is determined whether pausing the recording should be canceled or not (block B111). For example, if the recording button displayed instead of the pause button 500B is tapped, it is determined that the pausing should be canceled.

If it is determined that the recording should not be paused (No in block B109), the flow returns to B103 and the processing for recording and screen capture is continued. If it is determined that pausing the recording should be canceled (Yes in block B111), pausing the recording is canceled (block B112), the flow returns to block B103, and the processing for recording and screen capture is continued.

If it is determined that pausing the recording should not be canceled (No in block B111), it is determined whether the recording should be ended or not (block B113). For example, if the stop button 500A on the recording view 210-2 is tapped during the pausing, it is determined that the recording should be ended. If it is determined that the recording should not be ended (No in block B113), the flow returns to block B111 and it is determined again whether pausing the recording should be canceled or not.

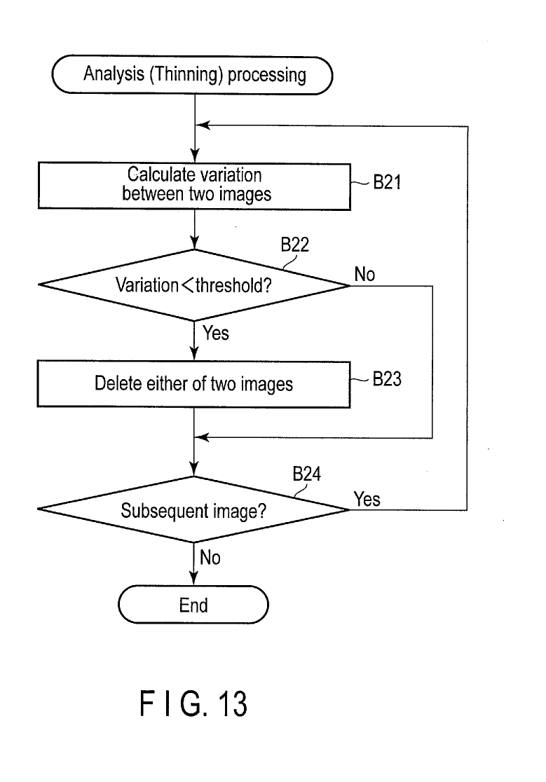

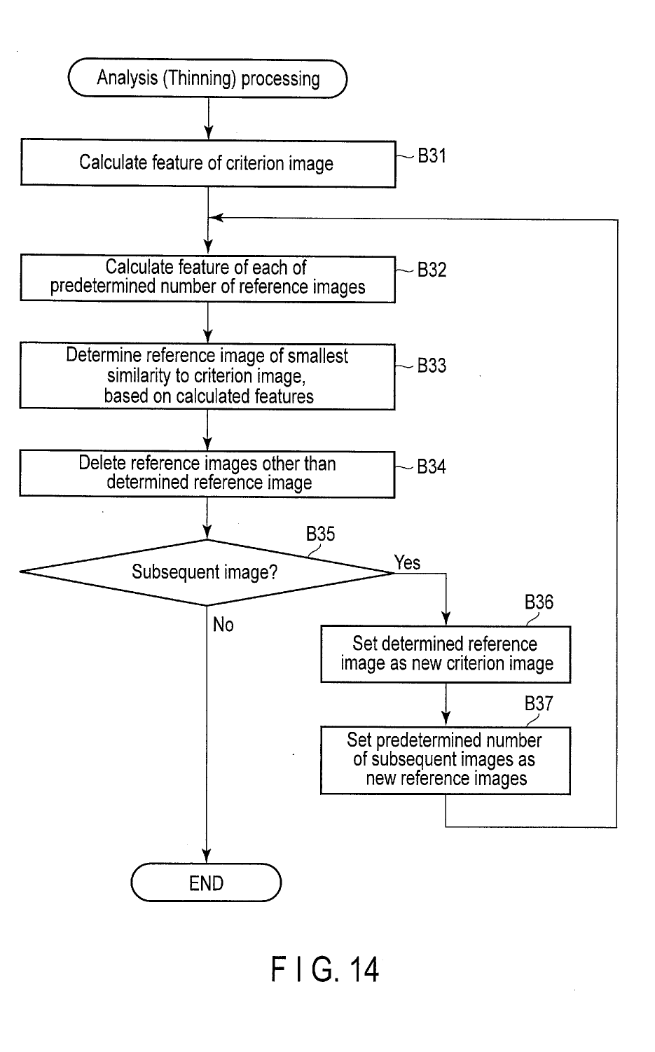

If it is determined that the recording should be ended (Yes in block B105 or Yes in block B113), the recording is ended (block B106). Then, the analysis (thinning) processing for deleting redundant images in the screen images (first images) stored in the nonvolatile memory 107 or the like is executed (block B107). The procedure of the analysis processing will be explained later with reference to FIG. 13 and FIG. 14.

The index data 107B corresponding to the recorded audio data 107A is updated based on the analysis result (block B108). For example, the storage area corresponding to the image (i.e., the time stamp of the image) deleted by the analysis, in the index data 107B is accessed, and the value “yes” stored in the “screen capture” field of the storage area is changed to “no”.

Flowcharts of FIG. 13 and FIG. 14 show examples of the procedure of the analysis (thinning) processing to delete redundant images in the screen images (first images) captured during the recording.

An example of the procedure of implementing the analysis processing shown in FIG. 4 will be explained with reference to the flowchart in FIG. 13.

A variation between two images, of screen images in order of production time as captured during the recording is calculated (block B21). The variation between the images is, for example, a sum of difference between corresponding pixels in two images.

It is determined whether the calculated variation is smaller than a threshold value or not (block B22). If the calculated variation is smaller than the threshold value (Yes in block B22), either of the two images is deleted (block B23). If the calculated variation is greater than or equal to the threshold value (No in block B22), the procedure of block B23 is skipped.

Then, it is determined whether a subsequent screen image is present or not (block B24). If a subsequent screen image is present (Yes in block B24), the flow returns to block B21, and the analysis processing of the image (i.e., the processing of determining whether the image should be deleted or not) is executed. If a subsequent image is not present (No in block B24), i.e., if the analysis of all the screen images captured during the recording is completed, the analysis processing is ended.

An example of the procedure of implementing the analysis processing shown in FIG. 5 will be explained with reference to the flowchart in FIG. 14.

A feature of the criterion image, of screen images in order of production time as captured during the recording is calculated (block B31). The initial criterion image is, for example, a screen image initially produced (captured) during the recording.

Then, features of reference images (for example, three images) subsequent to the criterion image are calculated (block B32). The reference image having the smallest similarity is determined to the criterion image, of the reference images, based on the calculated features (block B33). In other words, the reference image having the most different feature from the criterion image is determined. The reference images other than the determined reference image are deleted (block B34).

It is determined whether images subsequent to the reference images are included in the screen images in order of production time or not (block B35). If the subsequent images are included (Yes in block B35), the reference image determined in block B33 is set as a new criterion image (block B36) and the subsequent images are set as new reference images (block B37). The flow returns to block B32 and the analysis processing of the newly set criterion image and reference images is executed. As a feature of the new criterion image, the feature calculated when the criterion image has been analyzed as the reference image can be used.

If subsequent images are not included (No in block B35), i.e., if the analysis processing of all the screen images captured during the recording is completed, the analysis is ended.

The features of the respective screen images may be preliminarily calculated before steps subsequent to block B33 are executed.

The screen images (i.e., the second images) obtained by deleting redundant screen images in the screen images (i.e., the first images) captured during the recording are stored in the nonvolatile memory 107, by the above-explained analysis processing shown in FIG. 13 or FIG. 14.

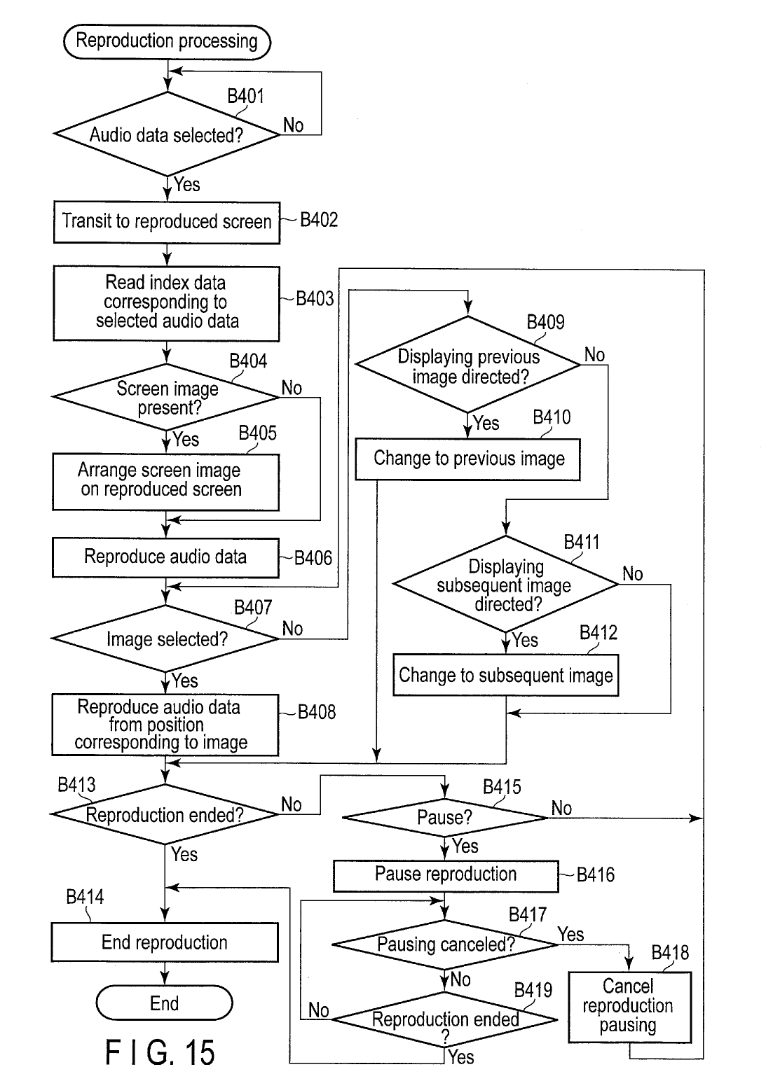

A flowchart of FIG. 15 shows an example of the procedure of reproduction processing for reproducing the recorded audio data. After completion of the analysis processing shown in, for example, FIG. 13 or FIG. 14, the reproduction is executed with the screen images (i.e., the second images) not deleted by the analysis processing.

First, it is determined whether the audio data 107A (record) to be reproduced is selected or not (block B401). For example, if a record is selected from the record list 403 in the home view 210-1, it is determined that the audio data 107A to be reproduced is selected. If the audio data 107A is not selected (No in block B401), the flow returns to block B401 and it is determined again whether the audio data 107A is selected or not

If the audio data 107A is selected (Yes in block B401), the displayed screen (home view 210-1) is transited to the reproduced screen (play view 210-3) (block B402). In addition, the index data 107B corresponding to the selected audio data 107A is read from the nonvolatile memory 107 (block B403).

It is determined whether the screen images (i.e., the second images) associated with the selected audio data 107A are present or not, by using the read index data 107B (block B404). If the screen images are present (Yes in block B404), the screen images are arranged on the reproduced screen (block B405). Similarly to play view 210-3 shown in FIG. 8, the screen images 731 to 737 are arranged at the positions corresponding to the times at which the respective images are produced, based on the time represented by the seek bar 711 to which the time from the start to the end of the audio data 107A to be reproduced is allocated, in the seek bar area 602. In addition, an image of the screen images 731 to 737 is displayed in the play view area 603. This image is, for example, a screen image corresponding to the current reproduction position or a screen image subsequent to the screen image corresponding to the current reproduction position.

If the screen images associated with the selected audio data 107A are not present (No in block B404), the procedure of block B405 is skipped.

Then, the audio data 107A is reproduced (block B406).

Then, it is determined whether the image arranged on the screen is selected or not (block B407). For example, if the image arranged on the screen is tapped, it is determined that the image arranged on the screen is selected. If the image is selected (Yes in block B407), the audio data 107A is reproduced from the position corresponding to the production time of the image (i.e., the reproduction position of the audio data 107A is jumped to the position corresponding to the production time of the image) (block B408).

If the image arranged on the screen is not selected (No in block B407), it is determined whether displaying the previous image is directed or not (block B409). For example, if the button 741 to direct displaying the previous image is tapped, it is determined that displaying the previous image is directed. If displaying the previous image is directed (Yes in block B409), the screen image displayed in the play view area 603 is changed to the previous screen image (block 8410).

If displaying the previous image is not directed (No in block B409), it is determined whether displaying the subsequent image is directed or not (block B411). For example, if the button 742 to direct displaying the subsequent image is tapped, it is determined that displaying the subsequent image is directed. If displaying the subsequent image is directed (Yes in block B411), the screen image displayed in the play view area 603 is changed to the subsequent screen image (block B412).

If displaying the subsequent image is not directed, the procedure of block B412 is skipped.

Then, it is determined whether the reproduction of the audio data 107A should be ended or not (block B413). For example, if the stop button on the control panel 604 is tapped, it is determined that the reproduction of the audio data 107A should be ended.

If the reproduction of the audio data 107A is not ended (No in block B413), it is determined whether the reproduction should be paused or not (block B415). For example, if the pause button on the control panel 604 is tapped, it is determined that the reproduction should be paused. If the pause button is tapped, a reproduction button 604A for resuming the reproduction may be displayed instead of the pause button.

If it is determined that the reproduction should be paused (Yes in block B415), the reproduction of the audio data 107A is paused (block B416). Then, it is determined whether pausing the reproduction should be canceled or not (block B417). For example, if the reproduction button 604A displayed instead of the pause button is tapped, it is determined that the pausing should be canceled.

If it is determined that the reproduction should not be paused (No in block B415), the flow returns to B407, the reproduction is continued, and the processing for accepting the user operation is continued. If it is determined that pausing the reproduction should be canceled (Yes in block B417), pausing the reproduction is canceled, i.e., the reproduction is resumed (block B418), the flow returns to block B407, and the processing for accepting the user operation is continued.

If it is determined that pausing the reproduction should not be canceled (No in block B417), it is determined whether the reproduction should be ended or not (block B419). For example, if the stop button on the control panel 604 is tapped during the pausing, it is determined that the reproduction should be ended. If it is determined that the reproduction should not be ended (No in block B419), the flow returns to block B417 and it is determined again whether pausing the reproduction should be canceled or not.

If it is determined that the reproduction of the audio data 107A should be ended (Yes in block B413 or Yes in block B419), the reproduction is ended (block B414).

In the present embodiment, as explained above, the CPU 101 causes the nonvolatile memory 107 to record audio data 107A corresponding to a sound input via the microphones 12R and 12L, and produces first images by capturing an image displayed on the LCD 21 while the audio data is recorded. The CPU 101 selects second images from the produced first images, based on variations between images. If the audio data is reproduced, the CPU 101 displays a third image of the selected second images on a screen of the display, the third image corresponding to the current reproduction position of the audio data.

A summary of the recorded data can be therefore presented comprehensibly to the user by the image displayed at reproduction of the recorded data. Since the user is capable of understand the contents of the sequence of the recorded data from the image and find a section in which the user wishes to listen to the recorded data, the user can efficiently listen to the recorded data.

Each of various functions described in the embodiment may be implemented by a circuit (processing circuit). Examples of the processing circuit include a programmed processor such as a central processing unit (CPU). The processor executes each of the described functions by executing the computer program (instruction group) stored in the memory. The processor may be a microprocessor comprising an electric circuit. Examples of the processing circuit include a digital signal processor (DSP), an application specific IC (ASIC), a microcomputer, a controller, and other electric circuit components. Each of the components other than CPU described in the embodiments may also be implemented by a processing circuit.

In addition, since various types of the processing of the present embodiment can be implemented by the computer program, the same advantages as those of the present embodiment can easily be obtained by installing the computer program in a computer via a computer-readable storage medium storing the computer program and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a memory;
a microphone;
a display; and
a hardware processor configured to:
cause the memory to record audio data corresponding to a sound input via the microphone;
produce first images by capturing an image displayed on the display while the audio data is recorded;
select second images from the first images, based on variations between images; and
display a third image of the second images on a screen of the display if the audio data is reproduced, the third image corresponding to a current reproduction position of the audio data.

2. The electronic device of claim 1, wherein the hardware processor is further configured to:
based on an operation for changing the displayed third image to a subsequent image, display a fourth image of the second images in order of production time, on the screen, the fourth image subsequent to the third image; and
based on an operation for selecting the displayed fourth image, change the current reproduction position of the audio data to a position corresponding to a time at which the fourth image has been produced.

3. The electronic device of claim 1, wherein the hardware processor is further configured to:
based on an operation for changing the displayed third image to a previous image, display a fourth image of the second images in order of production time on the screen, the fourth image previous to the third image; and
based on an operation for selecting the displayed fourth image, change the current reproduction position of the audio data to a position corresponding to a time at which the fourth image has been produced.

4. The electronic device of claim 1, wherein the hardware processor is further configured to:
if the audio data is reproduced, display a fourth image of the second images in order of production time on the screen, the fourth image subsequent to the third image corresponding to the current reproduction position of the audio data; and
based on an operation for selecting the displayed fourth image, change the current reproduction position of the audio data to a position corresponding to a time at which the fourth image has been produced.

5. The electronic device of claim 1, wherein the hardware processor is further configured to display a display area representing a sequence of the audio data, on the screen, and to display the second images at positions based on a time allocated to the display area and on times at which the second images are produced, respectively.

6. The electronic device of claim 5, wherein the hardware processor is further configured to, based on an operation for selecting one of the displayed second images, change the current reproduction position of the audio data to a position corresponding to a time at which the selected image is produced.

7. The electronic device of claim 1, wherein the first images are produced by capturing an image displayed on the display at each constant time while the audio data is recorded.

8. The electronic device of claim 1, wherein the second images are obtained by deleting one of two images of the first images in case where a variation between the two images is smaller than a threshold value.

9. The electronic device of claim 1, wherein
the first images in order of production time comprise a fourth image and fifth images subsequent to the fourth image,
a sixth image of the fifth images has smallest similarity to the fourth image, in the fifth images, and
the second images are obtained by deleting images other than the sixth image of the fifth images, from the first images.

10. A method executed by an electronic device, the method comprising:
causing a memory to record audio data corresponding to a sound input via a microphone;
producing first images by capturing an image displayed on a display while the audio data is recorded;
selecting second images from the first images, based on variations between images; and
displaying a third image of the second images on a screen of the display if the audio data is reproduced, the third image corresponding to a current reproduction position of the audio data.
